(19) United States
(12) Patent Application Publication
(10) Pub. No.: US 2005/0044177 A1
(43) Pub. Date: Feb. 24, 2005

(54) Mobile web browsing device

(76) Inventor: Jelte Liebrand, London (GB)

Correspondence Address: Richard C Woodbridge;Synnestvedt Lechner & Woodbridge, PO Box 592, Princeton, NJ, 08542-0592, US

(21) Appl. No.: 10/491,517

(22) PCT Filed: Oct. 1, 2002
(86) PCT No.: PCT/GB02/04448

(30) Foreign Application Priority Data
Oct. 2, 2001 (GB) 0123532.4
May 27, 2002 (GB) 0212175.4

(51) Int. Cl. G06F 15/16

(52) U.S. Cl. 709/218

(57) ABSTRACT

The origin server which supplies content to a client mobile web-browsing device cin tag content (e.g. a homepage) as ‘persistent’ by applying a special definition to that content, The content and accompanying definitions are then sent to the device over the cellular network. The browser on the device is programmed to recognise this definition and to set an appropriate flag against that content; the flag defines how the device uses the content—in particular, defining that the device will not discard that content front memory even when flushing the cache to free up disc space. Hence, flagged home pages can become persistent since they are not discarded from memory; as such they can reliably be viewed even when the device is out of cellular coverage and the device has freed up disc space.

### FIELD OF THE INVENTION

This invention relates to a mobile web browsing device. A web browsing device is a device that can access data on remote computers, the data being stored in a mark up language format such as HTML, WML etc.

### DESCRIPTION OF THE PRIOR ART

Mobile web browsing devices are well known: the most common device type is a WAP/web enabled mobile cellular telephone. When these devices are out of cellular network coverage, there is no guarantee that any WAP/web pages will be viewable at all on the device since even pages stored in cache memory on the device can be flushed at any point by the browser. Flushing occurs when the device is running low on disc space (e.g. Flash memory space); this may cause the device (or, more particularly, the device operating system) to ask applications running on the device to free up space; a browser typically responds by discarding the contents of its cache, which normally stores a record of recently viewed pages. The device user may also be able to flush the cache.

The homepage of a network operator is implemented as HTML content on an origin server on the portal side. The homepage is regarded as an important resource to both device users and to network operators. However, if this page is cached in local device memory using the standard cache management approach within the HTTP/1.1 protocol (defined in RFC 2616), the cache could, as noted above, be emptied at any point by the browser. The homepage would therefore disappear from the device. In order to ensure that this situation does not occur, a new approach to the standard cache management scheme is needed.

### SUMMARY OF THE INVENTION

In a first aspect, there is a mobile web browsing device able to download and store content from a web server over a wireless network, wherein the device is programmed to:
(a) recognise a useage definition applied to certain downloadable content, in which the definition prohibits discarding that content from a memory in the device;
(b) apply a flag to that content and store that content in combination with the flag in the device memory;
(c) not discard that content from the device memory, so that the content can reliably be displayed even when the device is out of network coverage and the device has freed up space in the device memory.

The present invention hence defines how, in an implementation, the origin server which supplies content to the client mobile web browsing device can tag content (e.g. a home page) as ‘persistent’ by applying a special definition to that content. For current generation web pages, these useage definitions are usually called ‘directives’. The content and accompanying definitions are then sent to the device over the cellular network controlled by a network operator. The browser on the device is programmed to recognise this definition and to set an appropriate flag against that content; the flag defines how the device uses the content—in particular, defining that the device will not discard that content from memory, even when flushing the cache memory to free up disc space when memory is running low. Flagged home pages stored on device memory are persistent since they are not routinely discarded from memory (e.g. on automatic or manual cache flushing). Hence, they can reliably be viewed even when the device is out of cellular coverage and the device has freed up disc space.

This approach allows a cellular network operator or other content provider to determine and control exactly what web pages are persistent on a device (i.e. are reliably accessible even when the device is unconnected and has flushed its cache) without any user intervention or input, by ensuring that those pages are sent out to browsing devices with the appropriate ‘persistent’ directive.

The homepage is a specific example of content that should be accessible to the user at any time (i.e. be reliably persistent). However it is up to the operator to determine if the same mechanism should be used for content other than their homepage. Typically, about 10 pages will be treated as persistent by an operator.

Any kind of mark-up language data can be flagged in this way; although the term ‘web’ is used in this specification, this term is not limited to HTML type content, but also includes all other forms of mark-up language, such as WML, XML etc. Hence, the terms web browsing, web browser, web server, web page should be expansively construed to cover any kind of mark up language browsing, browser, server, and page.

The device is typically programmed to not over-write flagged content with other content that needs to be stored in memory (over-writing could happen when memory is full). Further, the device may allow content, against which a flag has been set, to remain stored in memory and not discarded, but only provided that the flagged content has been looked at by a user within a pre-defined time period. This prevents content which is in fact unimportant to a user from taking up valuable space in memory.

The device may be a mobile telephone, smart phone, communicator, laptop computer, PDA, dedicated web terminal or similar. These devices will typically operate over wide area wireless networks such as GSM, UMTS, CDMA etc cellular networks. The device may optionally also (or alternatively) connect to the origin server using (at least in part) a local area wireless network, such as 902.11 or Bluetooth wireless networks.

The device may also check that the source of the definition (e.g. the origin web server) is present in a list of trusted resources defined at the build time of the device, and will then apply the flag if the source is in the trusted resource list. This prevent unauthorised entities from making use of the persistent content functionality of the present invention. The ability to control inclusion into the trusted resource file can be a valuable commercial asset.

The present invention may also be implemented in a browser application. Hence, in a second aspect, there is a software browser application, programmed to allow a mobile web browsing device to download and display content from a web server over a wireless network, wherein the application is further programmed to:
(a) recognise a useage definition applied to certain downloadable content, in which the definition prohibits discarding that content from a device memory;
(b) to apply a flag to that content;
(c) to not discard that content from the device memory, so that the content can reliably be displayed even when the device is out of network coverage and the device has freed up memory space.

Further, network operators and other content/service providers may also take advantage of the present invention. Hence, in a final aspect, there is a method of providing web content to a mobile web browsing device from a web server, for reliable display on that device, comprising the steps of:
(a) applying or causing to be applied a useage definition to certain downloadable web content, in which the definition prohibits discarding that content from a memory in the device; and
(b) sending or causing to be sent the downloadable content together with the useage definition over a wireless network for receipt by the device.

As noted above, this aspect is most likely to be performed by a cellular network operator to enable its homepage content to be persistent on cellular mobile telephones, despite those telephones being out of coverage and regularly automatically flushing cache memory.

### BRIEF DESCRIPTION OF THE DRAWINGS

The present invention will be described with reference to the accompanying drawings, in which

FIG. 1 shows a schematic flowchart of the operation of an implementation.

### DETAILED DESCRIPTION

Cache Management in HTTP/1.1

Conventional Cache Management in HTTP/1.1 is described in RFC2616. This section outlines those aspects of Cache Management that are relevant to implementing this invention.

Within the Cache Management of HTTP/1.1, the following is the syntax of Cache-Control:

Cache-Control = “Cache-Control” “:” 1#cache-directive
cache-directive = cache-request-directive

| cache-response-directive

cache-request-directive =

“no-cache” ;
| “no-store” ;
| “max-age” “=” delta-seconds ;
| “max-stale” [ “=” delta-seconds ] ;
| “min-fresh” “=” delta-seconds ;
| “no-transform” ;
| “only-if-cached” ;
| cache-extension ;

cache-response-directive = “public” ;

| “private” [ “=” <“> 1#field-name <”> ] ;
| “no-cache” [ “=” <“> 1#field-name <”> ];
| “no-store” ;
| “no-transform” ;
| “must-revalidate” ;
| “proxy-revalidate” ;
| “max-age” “=” delta-seconds ;
| “s-maxage” “=” delta-seconds ;
| cache-extension ;

cache-extension = token [ “=” ( token | quoted-string ) ]

In section 14.9.6 of RFC2616 this “cache-extension” is explained in more detail.

This extension model is utilised in the Out-Of-Coverage solution proposed in this invention.

The requirements for this solution can be summarised as follows:
For some content (note: not all), it is required that the content is always available for the user. Even when out of coverage, the user should be able to browse the content, even if it is not the latest version. Naturally, this only applies to content the user has browsed before, when still within coverage. When attempting to browse to “new” content when out of coverage, a default welcome page will be shown.
When certain entries within the cache are never deleted, this automatically leads to the possibility of ‘bloating’ the cache. This should be avoided.
This Out-Of-Coverage scheme is intended for the operator to enable an Out-Of-Coverage solution for their homepage. It should not be possible for any other content provider to (ab)use this scheme.

The present invention implements these requirements as follows:

Content Always Available

Although the standard cache management scheme can be used to browse content when out of coverage, it can not be relied upon to guarantee the existence of particular content. Since the browser can flush its cache when needed, content previously visited will be removed. Therefore an extension to the cache-control response-directive within the HTTP/1.1 Cache Management is required. The cache-extension Never-Flush is introduced. The ‘Never-Flush’ extension is a directive which applies to particular HTML content defined by the content owner.

The client (i.e. the mobile web browsing device) handles entries (i.e. downloaded HTML content) with this directive as follows:
1. Never delete this entry from the Cache.
2. Never overwrite this entry with other content that needs to be cached. This could happen when the cache is full, but should not occur for these entries.
3. Use standard directives for the further handling of this entry. (eg: Must-Revalidate, Private etc. Note these cache-control directives are examples; not all responses will contain these, but they could)
   Note: the origin server supplying the HTML content should only use the Never-Flush directive on non-transient content; if used for transient content, there is a high risk of bloating the cache to the extent that it will not be usable. See section Never Bloat the Cache for more on this.
   Syntax

The cache-response-directive will be extended according to the below syntax (in italics):

cache-response-directive = “public” ;

| “private” [ “=” <“> 1#field-name <”> ] ;
| “no-cache” [ “=” <“> 1#field-name <”> ];
| “no-store” ;
| “no-transform” ;
| “must-revalidate“ ;
| “proxy-revalidate” ;
| “max-age” “=” delta-seconds ;
| “s-maxage” “=” delta-seconds ;
| “never-flush” ;

Pre-Installed Content

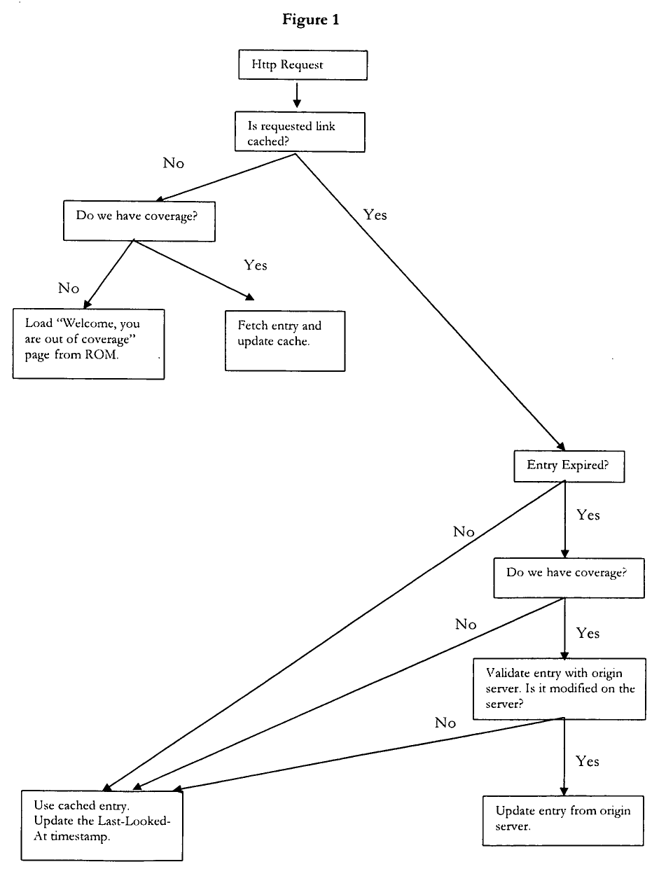

To allow for the operator's homepage to always be accessible even when a user requests a link to a page that is not cached and the device is out of coverage, it is required that a page is available in a specific section of the ROM (see the Cache Mechanism Diagram FIG. 1 for more details). This pre-installed page should naturally not contain any time-related content, it should be formed in a “Welcome, you are out of coverage”. The home page (persistently stored in cache) can then be easily reached from this pre-installed page by the user selecting a prominent home page icon. The pre-installed page should be customisable at build time. Hence, if a mobile web browsing device has an operating system and/or browser that implements the present invention and which has been designed for a specific manufacturer (e.g. Motorola or Nokia), for use with a specific network (e.g. Orange), then the pre-installed page can be built into ROM at build time.

Never Bloat the Cache

In order to ensure that the cache does not get bloated, there should be a mechanism to delete even the Never-Flush items. Although this is in contrast to the items always being available, it is necessary as shown below.

### EXAMPLE

The operator's homepage is marked as Never-Flush. Therefore it will always be in cache and thereby available even when the user is out-of-coverage. This also means that any items on this homepage should have the same cache directive (Never-Flush); for instance a little bitmap that was on the page.

Now if the homepage gets updated, and the bitmap gets removed, that bitmap is still in the cache, and will never be deleted and hence unnecessarily bloats the cache.

Last-Looked-At

Apart from adding the cache-control directive Never-Flush, the entries in the cache should also have a “last-looked-at” field. This is different from the standard “last-loaded” field in the sense that it is purely an indication of when the user looked at this entry last. The “last-loaded” field however indicates when this page was last loaded from the server, which could be different from when the user last looked at the page.

When the browser deletes items in the cache, it will decide to even delete Never-Flush cached entries when they have not been looked at for over a month (for example). In other words the Never-Flush entries have a duration of how long they can “live” in the cache.

Theoretically, the homepage could thereby also be deleted, but only when the user has not looked at it for over a month. The “Welcome, you are out of coverage” page from the ROM will be used in this case. More specifically: when the user hasn't looked at the homepage for over a month and then decides to look at it when also out-of-coverage, the pre-loaded “Welcome, you are out of coverage” page from the ROM will be used.

This should not be a problem, since the user would not want to see months-old news on the homepage in any case. In fact, (s)he might have completely forgotten what to expect on the homepage and a welcome page is then a good thing. Note: for the homepage itself to be deleted rather than an image alone is an extremely unusual case but could happen: for example, when the device is first purchased, or the device has not been used for several months (so that the ‘last-looked-at functionality has deleted the ‘persistent’ homepages stored in cache). ‘Welcome to the homepage’ page is built in ROM and will be displayed if the device is out of coverage.

### SUMMARY

With the Cache-Control directive Never-Flush and a “Last-Looked-At” time stamp in the cache, we ensure that the operator has the opportunity to handle out-of-coverage scenarios for their homepage and at the same time not bloat the cache. The overall approach is illustrated schematically at FIG. 1.

The duration of how long the Never-Flush entries can “live” in the cache is customisable.

Abuse Proof

Since this new scheme is intended only for the operator to cover Out-Of-Coverage scenarios for their homepage, it should be impossible for other unauthorised content providers to abuse this functionality.

In order to ensure this, the Cache-Management only acknowledges the new Never-Flush directive when issued by the operator's portal. It does so by checking the domain of the HTTP Response and comparing that to a “known-trusted-domain” which is defined in a secure resource file (for example, one defined at device build time).

For any responses from the portal's domain, the cache-control directive Never-Flush will be acknowledged and the appropriate flag will be set for that cached entry. If the domain of the response is different than the one known to be the portals, the Never-Flush cache-control directive will simply be ignored.

1. A mobile web browsing device able to download and store content from a web server over a wireless network, wherein the device is programmed to:
(a) recognise a useage definition applied to certain downloadable content, in which the definition prohibits discarding that content from a memory in the device;
(b) apply a flag to that content and store that content in combination with the flag in the device memory;
(c) not discard that content from the device memory, so that the content can reliably be displayed even when the device is out of network coverage and the device has freed up space in the device memory.

2. The device of claim 1 programmed to not over-write flagged content with other content that needs to be stored in memory.

3. The device of claim 1, programmed to allow content, against which a flag has been set, to remain stored in memory and not discarded, provided that the flagged content has been looked at by a user within a pre-defined time period.

4. The device of claim 1 in which the flagged content comprises elements of a homepage of a network operator.

5. The device of claim 1 which checks that the source of the definition is present in a list of trusted resources, and only applies the flag if the source is in the trusted resource list.

6. The device of claim 1, being a mobile telephone.

7. A software browser application, programmed to allow a mobile web browsing device to download and display content from a web server over a wireless network, wherein the application is further programmed to:
(a) recognise a useage definition applied to certain downloadable content, in which the definition prohibits discarding that content from a device memory;
(b) apply a flag to that content;
(c) to not discard that content from the device memory, so that the content can reliably be displayed even when the device is out of network coverage and the device has freed up memory space.

8. A method of providing web content to a mobile web browsing device from a web server, for reliable display on that device, comprising the steps of:
(a) applying or causing to be applied a useage definition to certain downloadable web content, in which the definition prohibits discarding that content from a memory in the device; and
(b) sending or causing to be sent the downloadable content together with the useage definition over a network for receipt by the device.

9. The method of claim 8 in which the wireless network is a wide area cellular network or a local area wireless network.

10. The method of claim 9, as performed by a cellular network operator or other provider of goods or services which relate to the web content.
